(19) United States
(12) Patent Application Publication
(10) Pub. No.: US 2014/0326384 A1
(43) Pub. Date: Nov. 6, 2014

(54) STUDDED TIRE

(71) Applicants: COMPAGNIE GENERALE DES ETABLISSEMENTS MICHELIN, Clermont-Ferrand (FR); MICHELIN RECHERCHE ET TECHNIQUE S.A., Granges-Paccot (CH)

(72) Inventors: Daniel Fabing, Clermont-Ferrand (FR); Illyès Batnini, Clermont-Ferrand (FR)

(21) Appl. No.: 14/366,258

(22) PCT Filed: Dec. 14, 2012
(86) PCT No.: PCT/EP2012/075613

§ 371 Date: Jun. 17, 2014

Related U.S. Application Data
(60) Provisional application No. 61/610,282, filed on Mar. 13, 2012.

(30) Foreign Application Priority Data
Dec. 21, 2011 (FR) 1162122

(51) Int. Cl. B60C 11/16

(52) U.S. Cl. CPC B60C 11/16
USPC 152/210

(57) ABSTRACT

Tire designed to roll on ground that may be covered with ice, comprising: a tread made of at least one rubber compound and having a tread surface, a plurality of housings opening onto the tread surface via an orifice and containing a stud, the orifice having a maximum dimension D0 on the tread surface when the stud is in the housing; the stud comprising: a base, designed to anchor the stud in the tread; a tip, designed to project from the tread in order to come into contact with the ice; a body connecting the base and the tip, the body having an axis of symmetry; and a longitudinal axis passing through the axis of symmetry of the body; wherein the tread surrounding the stud forms an anchoring platform for the stud, this platform in turn being surrounded by a cavity opening onto the tread surface so that the volume of recess opening onto the tread surface in a radius greater than or equal to D0/2 and less than or equal to D0/2+2 mm about the longitudinal axis of the stud is less than or equal to 20 mm³; and the volume of recess opening onto the tread surface in a radius greater than or equal to D0/2+2 mm and less than or equal to D0/2+4 mm about the longitudinal axis of the stud is greater than or equal to 60 mm³ and less than or equal to 100 mm³.

This application is a 371 national phase entry of PCT/EP2012/075613, filed 14 Dec. 2012, which claims benefit of FR 1162122, filed 21 Dec. 2011, and of U.S. Provisional Application Ser. No. 61/610,282, filed 13 Mar. 2012, the entire contents of each of which are incorporated herein by reference for all purposes.

### BACKGROUND

1. Field

The present disclosure relates to tires for driving on ice comprising studs (“studded tires”).

2. Description of Related Art

Studded tires have undeniable advantages in terms of how they behave under winter driving conditions, for example when driving on an icy road surface. Contact with the ice, and more particularly the way in which the stud digs into the ice compensates for the reduction in grip observed at the tread pattern of the tire tread. The studs scratch the ice and generate additional forces on the ice.

One of the difficulties in using studded tires is that the grip values reach their upper limit at values that are inferior to those that could be expected.

In order to overcome this difficulty, it has been proposed (see, for example patent applications WO 2009/147046 and WO 2009/147047) to provide grooves or cavities in the tread, near the stud, so that any shavings or particles of ice that are generated when the stud scratches the ice can be removed more quickly. As these shavings are removed more quickly, the thickness of the interface between the tread surface of the tire and the surface of the ice is reduced, which in turn increases the effective protrusion (or depth to which the ice is scratched) and results in a more positive anchorage in the ice and appreciably improves performance in terms of grip on ice.

While this approach has allowed a significant improvement in the grip of a tire comprising studs for driving on ice, there is still some room to improve the compromise between the level of grip on ice and stud retention when the tire is used on asphalt.

### SUMMARY

One of the objectives of embodiments of the present invention is to improve the compromise between the level of grip achieved by the studs on ice and stud retention when the tire used on asphalt.

This objective is achieved using an embodiment that includes a tire designed to roll on ground that may be covered with ice, comprising:
a tread made of at least one rubber compound and having a tread surface, a plurality of housings opening onto the tread surface via an orifice and containing a stud, the orifice having a maximum dimension D0 on the tread surface when the stud is in the housing;
the stud comprising: a base, designed to anchor the stud in the tread; a tip, designed to project from the tread in order to come into contact with the ice; a body connecting the base and the tip, the body having an axis of symmetry; and a longitudinal axis passing through the axis of symmetry of the body;
wherein the tread surrounding the stud forms an anchoring platform for the stud, this platform in turn being surrounded by a cavity opening onto the tread surface so that:
the volume of recess opening onto the tread surface in a radius greater than or equal to D0/2 and less than or equal to D0/2+2 mm about the longitudinal axis of the stud is less than or equal to 20 mm³; and
the volume of recess opening onto the tread surface in a radius greater than or equal to D0/2+2 mm and less than or equal to D0/2+4 mm about the longitudinal axis of the stud is greater than or equal to 60 mm³ and less than or equal to 100 mm³.

According to a first advantageous embodiment, the maximum depth of the cavity is less than or equal to HA/2, where HA is the depth of the housing containing the stud. Depths greater than HA/2 in fact lead to impaired stud retention.

According to a second advantageous embodiment, at least one bridge of rubber compound connecting the anchoring platform for the stud to the remainder of the tread passes across and through the cavity. This traverse of the cavity can be described as being such as locally to reduce the depth of the cavity. The existence of such a bridge improves the retention of the studs on ground that is tarmacked, wet, covered with snow and/or with ice.

For preference, the number of bridges of rubber compound passing through the cavity is greater than 1, which makes it possible to improve the anchoring of the stud in several directions perpendicular to the radial direction.

For preference, the number of such bridges of rubber compound is greater than or equal to 3 and the bridges are evenly distributed about the stud.

In one particularly advantageous configuration, the number of bridges evenly distributed about the stud is equal to 6. This number is high enough to guarantee good stud retention even in case one of the bridges became severed.

The bridges of rubber compound may intersect with the tread surface of the tire in the as-new (unworn) condition, or they may have no intersection with the tread surface of the tire in the as-new (unworn) condition.

For preference, the bridges of rubber compound have a rounded geometry, which reduces the risk of cracks spreading towards the inside of the tread.

According to a third preferred embodiment, the cavity surrounding the anchoring platform for the stud narrows as a function of depth.

The person skilled the art will understand that it is possible, and often desirable to combine several, or even all, of the embodiments mentioned hereinabove.

### BRIEF DESCRIPTION OF THE DRAWINGS

FIG. 1 depicts a tire according to the prior art fitted with studs.

FIG. 2 depicts a stud according to the prior art.

FIG. 3 depicts a stud housing according to the prior art.

FIG. 4 depicts a stud inserted in a stud housing, according to the prior art.

FIGS. 5 and 6 illustrate how studded tires according to the prior art work.

FIGS. 7 and 8 depict a portion of the tread of such a tire according to the prior art.

FIGS. 9 to 11 depict a portion of the tread of a tire according to an embodiment of the invention.

FIGS. 12 to 15 show a portion of a tread of a tread of a tire according to an embodiment of the invention, before and after the insertion of a stud.

FIG. 16 depicts a mould element for moulding a portion of a tread of a tire according to an embodiment of the invention.

FIG. 17 is a plan view of a rubber block 40 of the tread according to an embodiment of the invention.

### DETAILED DESCRIPTION OF SPECIFIC EMBODIMENTS

In the use of the term “radial” it is appropriate to make a distinction between the many various usages made of that word by the person skilled in the art. First of all, the expression refers to a radius of the tire. It is with that meaning that a point P1 is said to be “radially inside” a point P2 (or “radially on the inside of” the point P2) if it is closer to the axis of rotation of the tire than is the point P2. Conversely, a point P3 is said to be “radially outside” a point P4 (or “radially on the outside of” the point P4) if it is further away from the axis of rotation of the tire than is the point P4. Progress is said to be “radially inwards (or outwards)” when in the direction of smaller (or larger) radii. Where radial distances are concerned, it is this meaning of the term that applies also.

By contrast, a thread or a reinforcement is said to be “radial” when the thread or the reinforcing elements of the reinforcement make with the circumferential direction an angle that is greater than or equal to 80° and less than or equal to 90°. Let it be emphasized that, in this document, the term “thread” is to be understood in an entirely general sense and covers threads in the form of monofilaments, multi-filaments, a cord, a folded yarn or an equivalent assembly and irrespective of the material of which the thread is made or of the surface treatment it may have received in order to enhance its bonding with the rubber.

Finally, a “radial section” or “radial cross section” here means a section or cross section in a plane that contains the axis of rotation of the tire.

An “axial” direction is a direction parallel to the axis of rotation of the tire. A point P5 is said to be “axially inside” a point P6 (or “axially on the inside of” the point P6) if it is closer to the mid-plane of the tire than is the point P6. Conversely, a point P7 is said to be “axially outside” a point P8 (or “axially on the outside of” the point P8) if it is further away from the mid plane of the tire than is the point P8. The “mid plane” of the tire is the plane perpendicular to the axis of rotation of the tire and which lies at equal distances between the annular reinforcing structures of each bead. When it is said that, in any radial cross section, the mid plane divides the tire into two tire “halves”, that does not mean that the mid plane necessarily constitutes a plane of symmetry of the tire. The expression “tire half” here has a broader meaning and denotes a portion of the tire that is of an axial width close to half the axial width of the tire.

A “circumferential” direction is a direction which is perpendicular both to a radius of the tire and to the axial direction.

The “tread surface” of a tread here denotes all of the points of the tread which come into contact with the ground when the tire—inflated to its service pressure and without studs—is rolling on the ground.

In the context of this document, the expression “rubber compound” denotes a compound of rubber containing at least one elastomer and a filler.

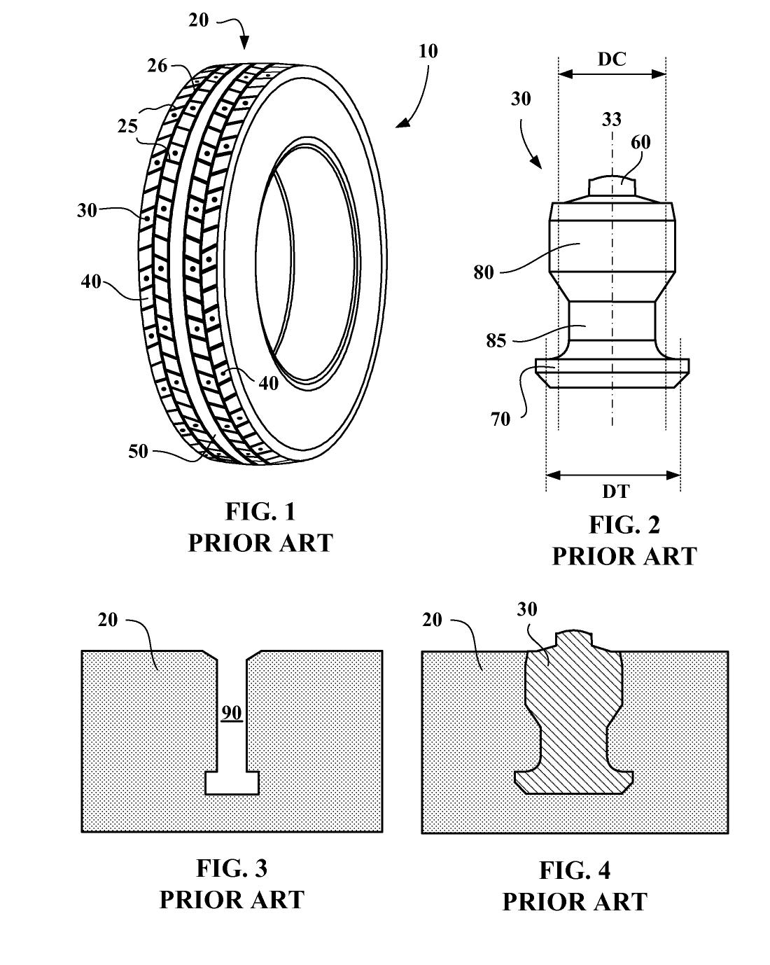

FIG. 1 schematically depicts a tire 10 according to the prior art comprising a tread 20 having a tread surface designed to come into contact with the ground when the tire is rolling. The tread 20 comprises a plurality of transverse grooves 25 and of circumferential grooves 26 and a plurality of studs 30. The studs 30 are arranged across the entire width of the tread surface in rubber blocks 40 of the tread 20; “rubber blocks” mean an element of the tread made of vulcanized rubber compound and delimited by grooves. The central rib 50 of the tread may also be fitted with studs 30. The studs 30 are arranged in various positions around the periphery of the tire so that at any instant there are studs in contact with the ground on which the tire is rolling.

FIG. 2 schematically depicts a stud 30 according to the prior art. The stud 30 has a longitudinal axis 33. The profile of the stud 30 is cylindrical and centred on the axis 33. The stud 30 has two axial ends: one of the axial ends defines a first part, here embodied by a tip 60, designed to come into contact with the ground (the ice, the snow or the bare road surface) when the stud 30 is fitted to the tire 10 and the tire 10 is rolling on the ground. The tip may advantageously be made of a separate material from that of the rest of the stud. That allows a harder material to be used for this part, which is subject to very high mechanical stresses. It also makes it possible, for certain product families, to have a moulded or injection-moulded body to which a tip is attached. Obviously, it is also possible to use studs that are made entirely from a single material.

The other end of the stud 30 is formed of a base 70 which is designed to anchor the stud 30 in the tread 20 of the tire 10.

A body 80 connects the first part 60 and the base 70 of the stud 30. The mean diameter DC of the body is smaller than the mean diameter DT of the base 70 of the stud 30, these diameters being measured perpendicular to the axis 33 of the stud. The body 80 is separated from the base 70 by a part 85 the diameter of which is smaller than the diameters of the base and of the body.

FIG. 3 schematically depicts part of the tread 20 of the tire 10. This tread is provided with a housing 90. Each housing comprises a cylindrical portion open to the outside of the tread 20 of the tire 10 and is designed to cooperate with a stud 30.

FIG. 4 schematically depicts the same part of the tread 20 after the stud 30 has been inserted. Due to the elasticity of the rubber compound of which the tread is formed, the tread 20 perfectly envelops the stud 30 and anchors it firmly in the tire.

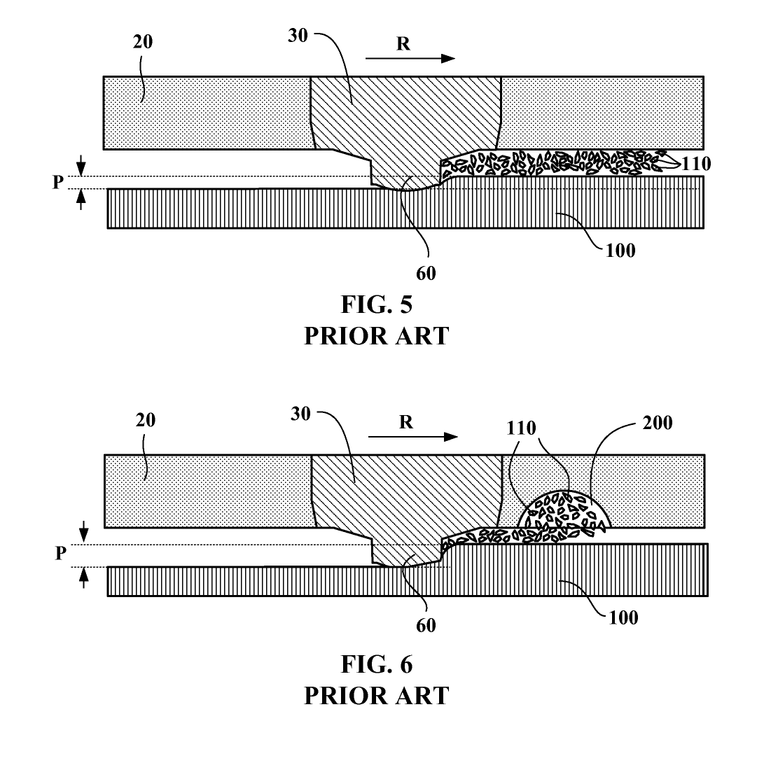

FIG. 5 illustrates how a first studded tire according to the prior art works. It depicts part of the stud 30 and of the tread 20 made of rubber compound which surrounds this part of the stud. The stud is depicted at the moment at which it comes into contact with the ice 100. The direction of rotation R of the tire is indicated using an arrow R. The first part 60 of the stud 30 digs into the ice 100 as far as a mean depth P. By digging into the ice 100 and scratching it, the stud 30 locally breaks the ice and generates a multitude of ice shavings 110 which accumulate at the interface between the tread 20 and the ice 100 and ultimately prevent the first part 60 of the stud 30 from digging deeply into the ice 100, and this therefore has a negative effect on tire grip.

FIG. 6 illustrates how an improved tire of the prior art (cf patent application WO 2009/147047), which is able to reduce this negative effect, works. Specifically, this tire comprises a cavity 200 in which the shavings 110 formed as the stud 30 digs into the ice 20, are stored. The shavings 110 therefore do not build up between the tread surface of the tread 20 and the ice 100. Thus, the stud 30 can dig further into the ice 100 so that a greater mean penetration depth P is obtained and the tire grips the ice better.

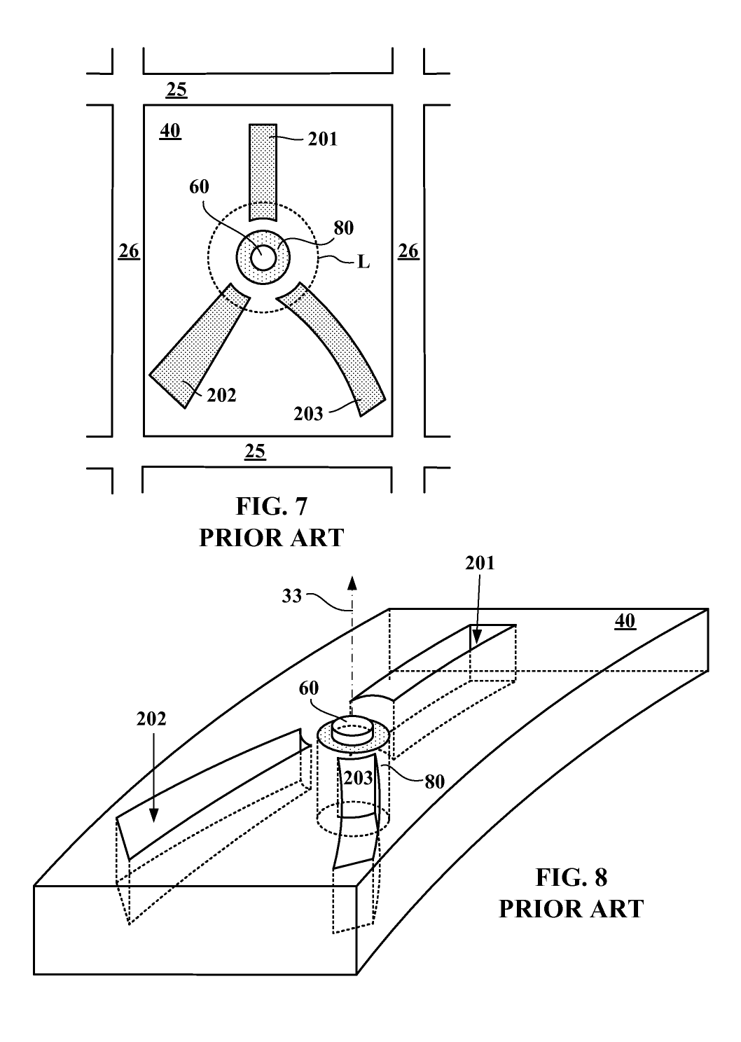

FIGS. 7 and 8 depict a portion of the tread of such a tire according to the prior art. These figures schematically depict a rubber block 40 of the tread 20 of the tire, viewed from a position radially on the outside of the tread (FIG. 7) and in perspective (FIG. 8). As FIG. 7 suggests, this rubber block 40 is surrounded by a plurality of other blocks and is separated from these other blocks by transverse 25 and circumferential 26 grooves.

The rubber block 40 comprises a stud having a longitudinal axis 33 (see FIG. 8), with a tip 60 projecting from the portion of tread surface formed by the rubber block 40. The stud is extended towards the inside of the tread by a body 80 (see FIG. 8), only a portion of which is suggested in dotted line. The rubber block 40 furthermore comprises three cavities 201 to 203 associated with the stud 30, each having a volume of 60 mm³.

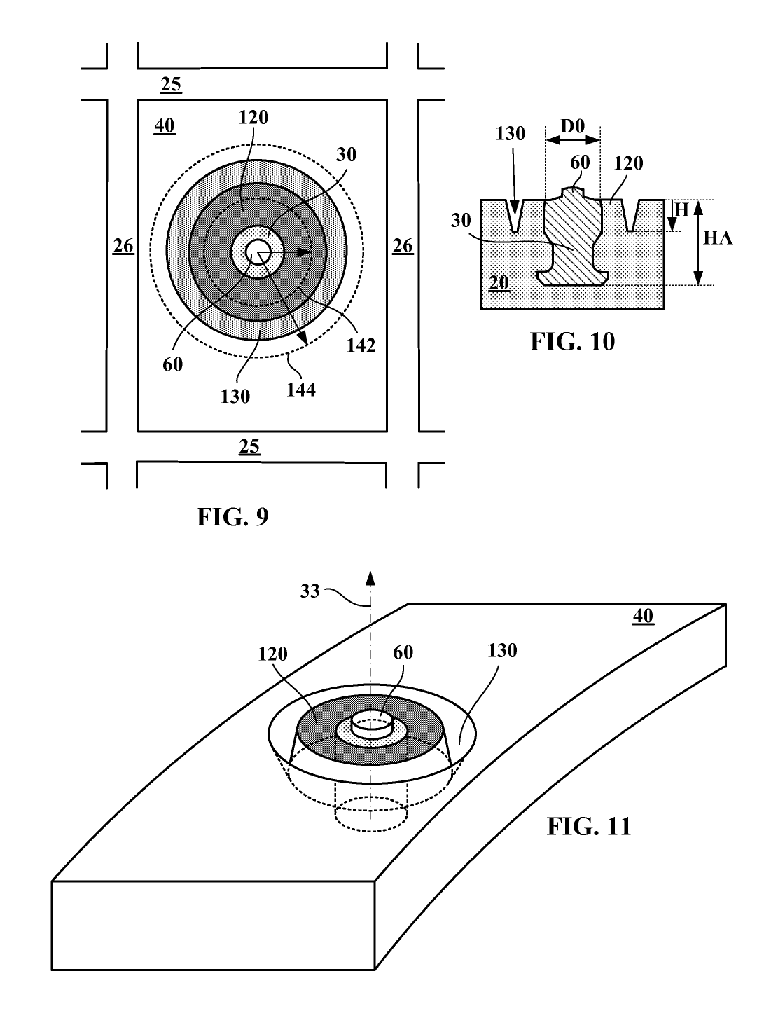

While this type of studded tire has allowed a significant improvement in grip on ice, there is still room to improve the compromise between the level of grip on ice and stud retention when the tire is used on asphalt. Such an improvement is obtained using a tire according to an embodiment of the invention, a portion of the tread of which is depicted in FIGS. 9 to 11. Here, the tread surrounding the stud (the tip 60 of which projects from the tread) forms an anchoring platform 120 for the stud, this platform being in turn surrounded by a cavity 130 that opens onto the tread surface, so that two conditions are satisfied.

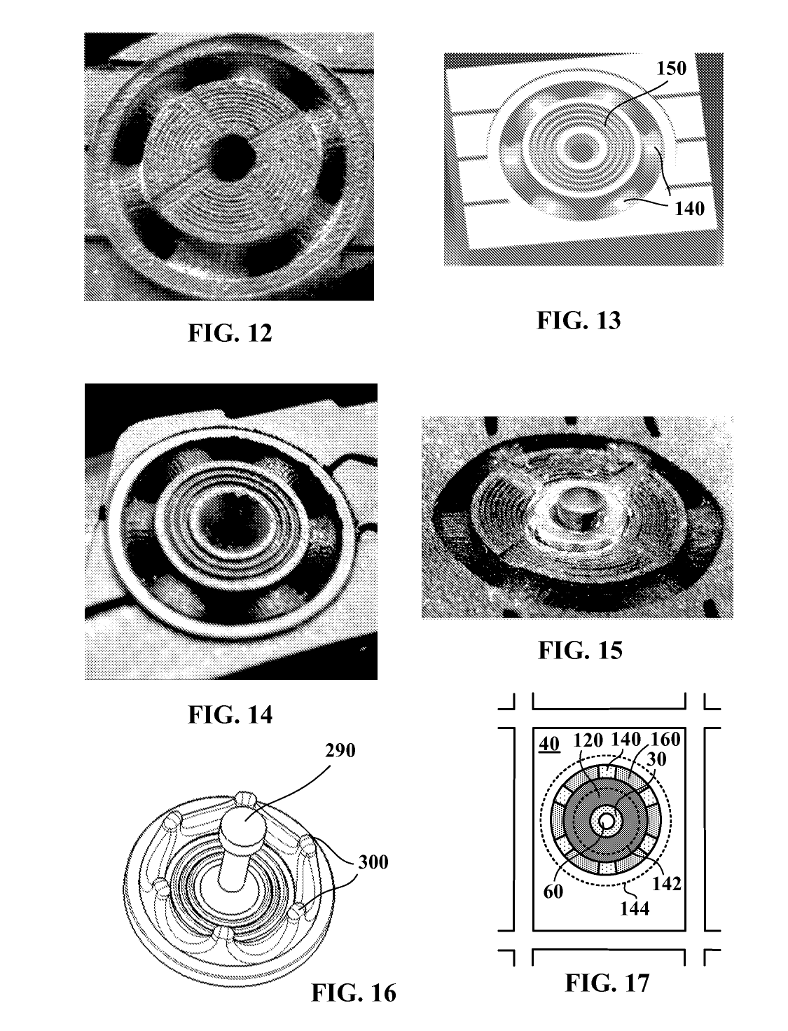

First, the volume of recess opening onto the tread surface in a radius greater than or equal to D0/2 (which here corresponds to the contour of the stud 30 on the tread) and less than or equal to D0/2+2 mm (indicated using the circle 142) about the longitudinal axis of the stud is less than or equal to 20 mm³ (For the stud depicted, D0 is equal to 6.5 mm) This condition corresponds to there being enough of an anchoring platform to anchor the stud firmly in the tread. There may be small cavities in this part, but in order not to compromise the anchoring significantly, these must not be voluminous. The applicant has found that a volume of 20 mm³ is a value not to be exceeded. The small cavities are depicted on the surface visible in FIGS. 12 to 15 and identified by 150 in FIG. 13.

Second, the volume of recess opening onto the tread surface in a radius greater than or equal to D0/2+2 mm (indicated using the circle 142) and less than or equal to D0/2+4 mm (indicated using the circle 144) about the longitudinal axis of the stud is greater than or equal to 60 mm³ and less than or equal to 100 mm³ (in this particular instance, the volume is 80 mm³) This condition corresponds to there being a cavity capable of holding a certain amount of ice shavings at a sufficiently small distance away from the axis of the stud.

For preference, the maximum depth H of the cavity is less than or equal to HA/2, where HA is the depth of the housing containing the stud (see FIG. 10). In this particular embodiment, the cavity surrounding the anchoring platform for the stud narrows as a function of depth.

According to one advantageous embodiment, at least one bridge of rubber compound connecting the anchoring platform for the stud to the remainder of the tread passes across and through the cavity. FIGS. 12 to 14 show a portion of a tire tread at the point where the anchoring platform is connected to the remainder of the tread by six bridges 140, before (FIGS. 12 to 14) and after (FIG. 15) insertion of a stud.

In this particular instance, the bridges do not intersect with the tread surface of the tire in the as-new condition, but it is also possible to provide bridges that do intersect with the tread surface in the as-new condition. The cavity surrounding the anchoring platform can in fact be formed of a plurality of cavities, each of which opens onto the tread surface. This is depicted in FIG. 17 as cavities 160.

The bridges visible in FIGS. 12 to 15 have a rounded geometry in terms of the shape of the bridges and/or the junctions with the cavity walls. This reduces the risk of the spread of cracks towards the inside of the tread. When, for other reasons, this risk is negligible, it is of course possible to provide bridges, the geometry of which comprises sharp corners. The shape of the bridges can be generally cylindrical.

FIG. 16 depicts a mould element for moulding the tread portion as shown in FIG. 14. It is possible to see a portion 290 designed to mould the housing 90 (see FIG. 3) and an annulus made up of teeth 300, designed to mould the bridges that connect the anchoring platform to the remainder of the tread.

Table 1 compares the results obtained with a studded tire that has no ice reservoir (“A”), used as reference, a studded tire according to WO 2009/147047 (“B”) and a tire according to an embodiment of the invention (“C”). The architecture of the tire and the materials used were the same for all three tires.

TABLE 1

| | “A” | “B” | “C” |
|---|---|---|---|
| Grip on ice | 100 | 110 | 105 |
| Stud retention | 100 | 90 | 115 |
| Compromise | 100 | 100 | 110 |

It may be seen that while solution “B” improves the grip on ice at the expense of stud retention, solution “C” improves both the grip on ice (even though not by as much as solution “B”) and especially improves stud retention; it therefore makes a very significant improvement to the overall grip/retention compromise.

1. A tire designed to roll on ground that may be covered with ice, comprising:
a tread made of at least one rubber compound and having a tread surface, a plurality of housings opening onto the tread surface via an orifice and containing a stud, the orifice having a maximum dimension D0 on the tread surface when the stud is in the housing;
wherein the stud comprises: a base, designed to anchor the stud in the tread; a tip, designed to project from the tread in order to come into contact with the ice; a body connecting the base and the tip, the body having an axis of symmetry; and a longitudinal axis passing through the axis of symmetry of the body;
wherein the tread surrounding the stud forms an anchoring platform for the stud, this platform in turn being surrounded by a cavity opening onto the tread surface so that:
the volume of recess opening onto the tread surface in a radius greater than or equal to D0/2 and less than or equal to D0/2+2 mm about the longitudinal axis of the stud is less than or equal to 20 mm³; and
the volume of recess opening onto the tread surface in a radius greater than or equal to D0/2+2 mm and less than or equal to D0/2+4 mm about the longitudinal axis of the stud is greater than or equal to 60 mm³ and less than or equal to 100 mm³.

2. The tire according to claim 1, wherein a maximum depth of the cavity is less than or equal to HA/2, where HA is the depth of the housing containing the stud.

3. The tire according to claim 1, further comprising at least one bridge of rubber compound connecting the anchoring platform for the stud to the remainder of the tread that passes across and through the cavity.

4. The tire according to claim 3, wherein the number of said bridges of rubber compound is greater than 1.

5. The tire according to claim 4, wherein the number of said bridges of rubber compound is greater than or equal to 3 and wherein the bridges are evenly distributed about the stud.

6. The tire according to claim 5, wherein the number of bridges is equal to 6.

7. The tire according to claim 1, wherein the cavity surrounding the anchoring platform for the stud narrows as a function of depth.

8. The tire according to claim 3, wherein the bridges of rubber compound intersect with the tread surface of the tire in the as-new condition.

9. The tire according to claim 3, wherein the bridges of rubber compound do not intersect with the tread surface of the tire in the as-new condition.

10. The tire according to claim 3, wherein the bridges of rubber compound have a rounded geometry.
